(19) United States
(12) Patent Application Publication
(10) Pub. No.: US 2024/0196461 A1
(43) Pub. Date: Jun. 13, 2024

(54) BEAM FAILURE RECOVERY WITH UPLINK ANTENNA PANEL SELECTION

(71) Applicant: APPLE INC., Cupertino, CA (US)

(72) Inventors: Yushu Zhang, Beijing (CN); Chunhai Yao, Beijing (CN); Chunxuan Ye, San Diego, CA (US); Dawei Zhang, Saratoga, CA (US); Haitong Sun, Cupertino, CA (US); Hong He, San Jose, CA (US); Huaning Niu, San Jose, CA (US); Oghenekome Oteri, San Diego, CA (US); Wei Zeng, Saratoga, CA (US)

(21) Appl. No.: 17/904,310

(22) PCT Filed: Sep. 24, 2021
(86) PCT No.: PCT/CN2021/120381

§ 371 Date: Aug. 16, 2022

(51) Int. Cl. H04W 76/19; H04L 5/00; H04W 74/00; H04W 74/0838

(52) U.S. Cl. CPC H04W 76/19; H04L 5/001; H04L 5/0053; H04W 74/004; H04W 74/0838

(57) ABSTRACT

Disclosed is a user equipment (UE) configured to perform beam failure recovery with uplink antenna panel selection. In some embodiments, the UE determines a first UE antenna panel corresponding to a candidate beam detection (CBD) reference signal (RS); reports to a gNB a beam failure recovery request (BFRQ), the BFRQ including UE antenna panel information for the first UE antenna panel; and after receiving from the gNB a response to the BFRQ, changes from a second UE antenna panel to the first UE antenna panel and corresponding configuration for uplink transmission.

### TECHNICAL FIELD

This application relates generally to wireless communication systems, including beam failure recovery with uplink antenna panel selection.

### BACKGROUND OF THE DISCLOSURE

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE), 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments. NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram showing an example architecture of a wireless communication system, according to embodiments disclosed herein.

FIG. 2 is a message sequence diagram, in accordance with one embodiment.

FIG. 3 is a message sequence diagram, in accordance with one embodiment.

FIG. 4 is a message sequence diagram, in accordance with one embodiment.

FIG. 5 is a table showing a PRACH-ResourceDedicatcdBFR information element, according to one embodiment.

FIG. 6 is a table showing a media access control (MAC) control element (CE) message, in accordance with one embodiment.

FIG. 7 is a flow chart of a process, in accordance with one embodiment.

FIG. 8 is a flow chart of a process, in accordance with one embodiment.

FIG. 9 is a block diagram showing a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

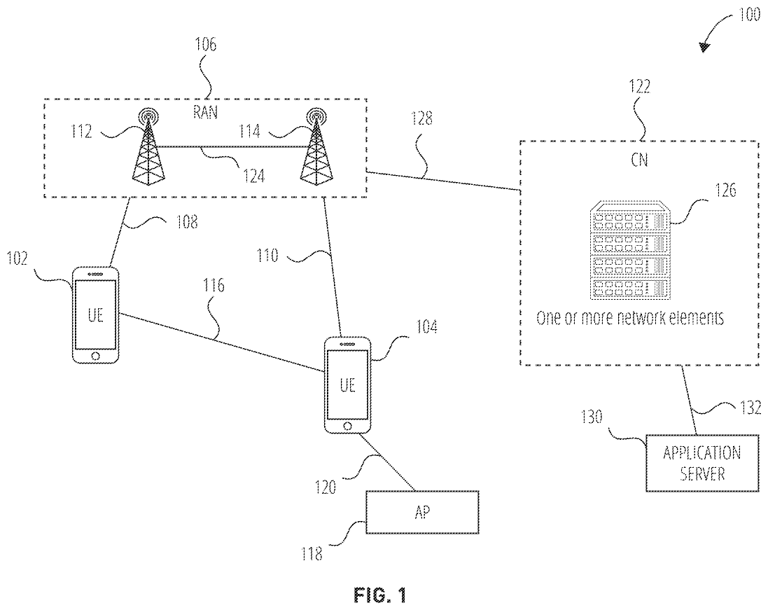

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, wireless communication system 100 includes UE 102 and UE 104 (although any number of UEs may be used). In this example, UE 102 and UE 104 are illustrated as smartphones (e.g., handheld touchscreen mobile computing devices connectable to one or more cellular networks), but may also comprise any mobile or non-mobile computing device configured for wireless communication.

UE 102 and UE 104 may be configured to communicatively couple with a RAN 106. In embodiments. RAN 106 may be NG-RAN, E-UTRAN, etc. UE 102 and UE 104 utilize connections (or channels) (shown as connection 108 and connection 110, respectively) with RAN 106, each of which comprises a physical communications interface. RAN 106 can include one or more base stations, such as base station 112 and base station 114, that enable connection 108 and connection 110.

In this example, connection 108 and connection 110 are air interfaces to enable such communicative coupling, and may be consistent with RAT(s) used by RAN 106, such as, for example, an LTE and/or NR.

In some embodiments, UE 102 and UE 104 may also directly exchange communication data via a sidelink interface 116. UE 104 is shown to be configured to access an access point (shown as AP 118) via connection 120. By way of example, connection 120 can comprise a local wireless connection, such as a connection consistent with any IEEE 702.11 protocol, wherein AP 118 may comprise a Wi-Fi® router. In this example, AP 118 may be connected to another network (for example, the Internet) without going through a CN 122.

In embodiments, UE 102 and UE 104 can be configured to communicate using orthogonal frequency division multiplexing (OFDM) communication signals with each other or with base station 112 and/or base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of base station 112 or base station 114 may be implemented as one or more software entities running on server computers as part of a virtual network. In addition, or in other embodiments, base station 112 or base station 114 may be configured to communicate with one another via interface 124. In embodiments where wireless communication system 100 is an LTE system (e.g., when CN 122 is an EPC), interface 124 may be an X2 interface. The X2 interface may be defined between two or more base stations (e.g., two or more eNBs and the like) that connect to an EPC, and/or between two eNBs connecting to the EPC. In embodiments where wireless communication system 100 is an NR system (e.g., when CN 122 is a 5GC), interface 124 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 122).

RAN 106 is shown to be communicatively coupled to CN 122. CN 122 may comprise one or more network elements 126, which are configured to offer various data and telecommunications services to customers/subscribers (e.g., users of UE 102 and UE 104) who are connected to CN 122 via RAN 106. The components of CN 122 may be implemented in one physical device or separate physical devices including components to read and execute instructions from a machine-readable or computer-readable medium (e.g., a non-transitory machine-readable storage medium).

In embodiments, CN 122 may be an EPC, and RAN 106 may be connected with CN 122 via an S1 interface 128. In embodiments, S1 interface 128 may be split into two parts, an S1 user plane (S1-U) interface, which carries traffic data between base station 112 or base station 114 and a serving gateway (S-GW), and the S1-MME interface, which is a signaling interface between base station 112 or base station 114 and mobility management entities (MMEs).

In embodiments, CN 122 may be a 5GC, and RAN 106 may be connected with CN 122 via an NO interface 128. In embodiments, NO interface 128 may be split into two parts, an NO user plane (NG-U) interface, which carries traffic data between base station 112 or base station 114 and a user plane function (UPF), and the S1 control plane (NG-C) interface, which is a signaling interface between base station 112 or base station 114 and access and mobility management functions (AMFs).

Generally, an application server 130 may be an element offering applications that use internet protocol (IP) bearer resources with CN 122 (e.g., packet switched data services). Application server 130 can also be configured to support one or more communication services (e.g., VoIP sessions, group communication sessions, etc.) for UE 102 and UE 104 via CN 122. Application server 130 may communicate with CN 122 through an IP communications interface 132.

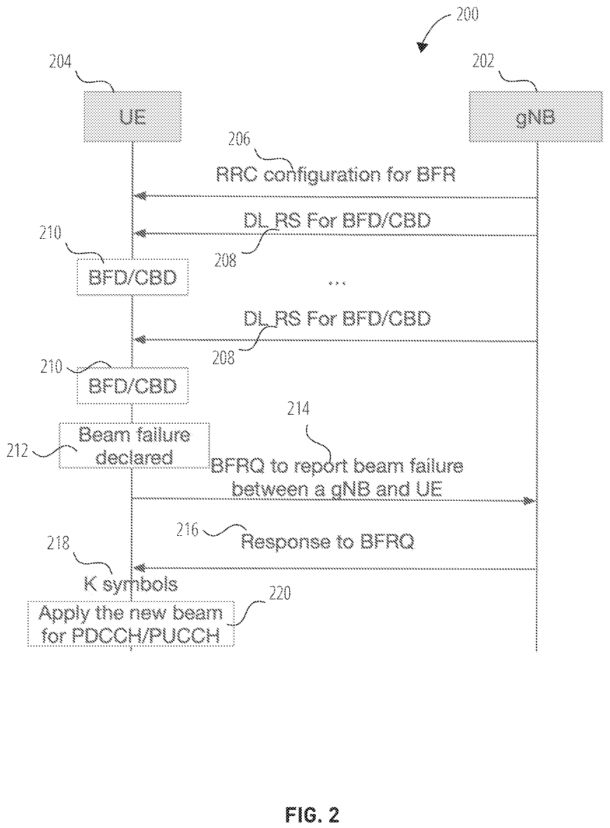

FIG. 2 shows a UE-specific beam failure recovery (BFR) procedure (BFR procedure 200) supported in Release 15 and 16 of the 3GPP standards. Initially, a gNB 202 provides to UE 204 an RRC configuration 206 for beam failure detection (BFD) and candidate beam detection (CBD). RRC configuration 206 indicates a downlink (DL) reference signal (RS) (RS 208) that UE 204 uses to detect 210 beam quality for physical downlink control channel (PDCCH) and thereby determine whether a beam failure happens. After it declares 212 a beam failure, UE 204 can report 214 the candidate beam information based on a beam failure recovery request (BFRQ). After receiving the BFRQ, gNB 202 can send a BFR response 216 to UE 204. After K symbols 218 (e.g., K=28 symbols) following receipt of BFR response 216 to the BFRQ, UE 204 can apply 220 the candidate beam to PDCCH (or a physical uplink control channel, PUCCH) automatically. UE 204 updates the power control parameters for PUCCH as well.

Antenna panels (i.e., a group of one or more antenna ports, also referred to as an antenna port group or simply, a panel) may be defined as having different numbers of ports, antenna port coherency, maximum transmission power, and the like. In Release 17 of the 3GPP standards, an uplink (UL) antenna panel selection is introduced in which, for each network beam. i.e., synchronization signal block (SSB)/channel state information reference signal (CSI-RS), a UE can report the corresponding antenna panel information.

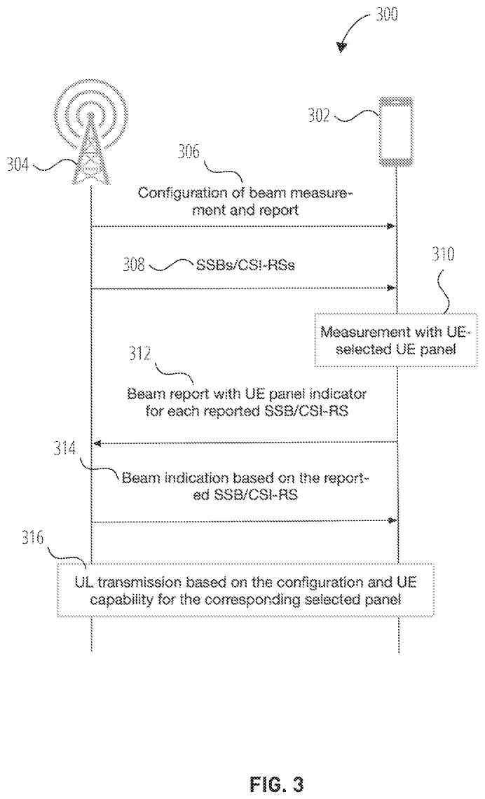

FIG. 3, for example, shows an example UL antenna panel selection procedure 300 performed between a UE 302 and a gNB 304. Initially, gNB 304 configures 306 UE 302 for beam measurement and reporting. In response to SSB/CSI-RS 308, UE 302 performs a measurement 310 with a UE-selected UE antenna panel. UE 302 provides a beam report 312 with a UE antenna panel indicator for each reported SSB/CSI-RS 308. In response, gNBs 304 updates the uplink transmission configuration (e.g., selected sounding reference signal (SRS) resource set for codebook/non-codebook based transmission, maximum number of layers for uplink transmission, codebook subset and so on) based on the reported UE panel indicator. And gNBs 304 provides a beam indication 314 based on the reported SSB/CSI-RS measurements. UE 302 may then provide a UL transmission 316.

For beam failure recovery, an outstanding issue for future implementations is how to report the UE antenna panel related information, which includes a UE panel related information report for contention-free random access (CFRA) based mechanism and a UE panel related information report for MAC CE (including contention-based random access, CBRA) based mechanism.

After a UE receives the BFR response, another issue is how to reset the beam and other configuration for uplink transmission, which includes the following (1) the target channel to be applied with the newly identified beam as well as the corresponding uplink configuration; (2) the support of carrier aggregation (CA) with component carriers (CCs) that share the same antennas; and (3) CCs that share the same antenna should be transmitted from the same panel.

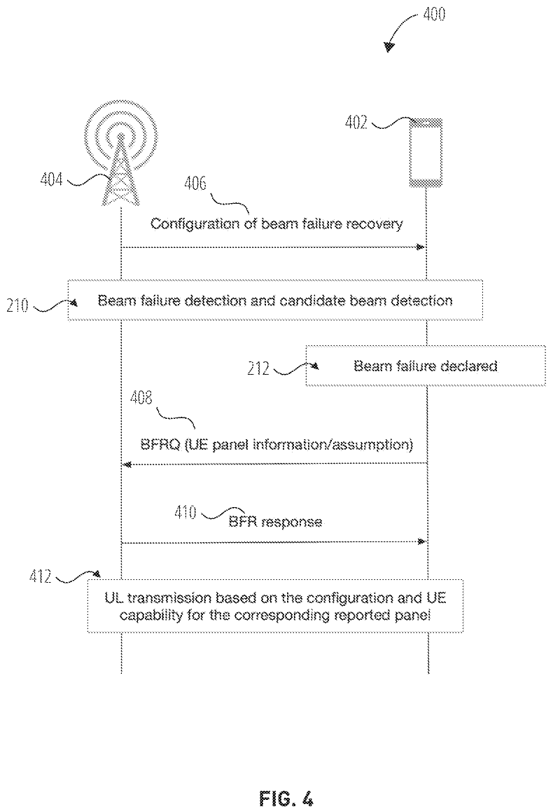

FIG. 4 shows a procedure 400 for beam failure recovery performed between a UE 402 and a gNBs 404. Initially, gNB 404 provides UE 402 a configuration 406 of beam failure recovery. As described previously with reference to FIG. 2, UE 402 performs beam failure detection 210 and declares 212 a beam failure. In BFRQ 408, UE 402 reports its antenna panel related information or antenna panel assumption. After UE 402 receives BFR response 410, after K symbols, a UL transmission 412 can be based on the reported/assumed panel as well as corresponding configuration and UE capability. This may be applied for signals within a CC or across CCs within a band or band group.

For CFRA-based BFRQ with panel information, the following options are set forth for a UE panel report.

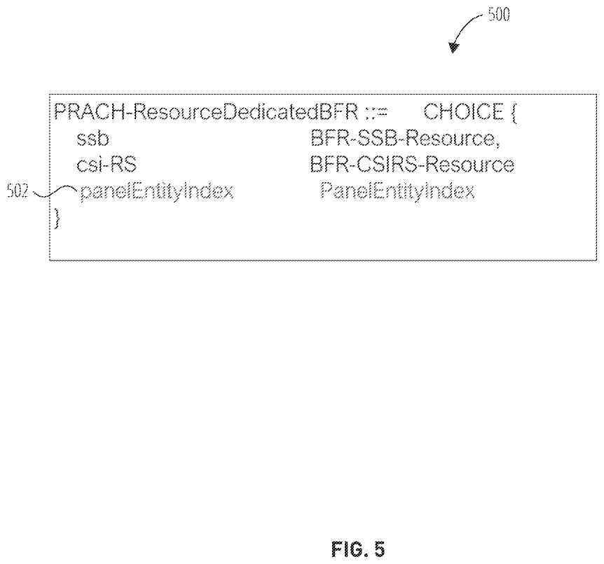

A first option is that a gNB can configure different CF-PRACH resources corresponding to different UE panel(s). A UE panel indicator may be configured in each CF-PRACH resource. As shown in FIG. 5, a UE can report in PRACH-ResourceDedicatedBFR 500 a panel entity index 502 via selected CFRA resource implicitly. For instance, the gNB can configure multiple CFRA resources as well as a panel ID for each resource. These resources can be associated with different panels. The UE can pick up one CFRA resource to report BFRQ, then after detection of the UE-selected CFRA resource, the gNB can get the panel information.

A second option is that a default UE panel is assumed, which may be predefined. For example, the first UE panel or UE panel with the smallest number of antenna ports, or reported by UE capability.

A third option is that a CFRA-based BFRQ should not be enabled for a UE with uplink panel selection enabled.

For MAC CE-based BFRQ (including CBRA based BFRQ) with panel information, the following options are set forth for a UE panel report.

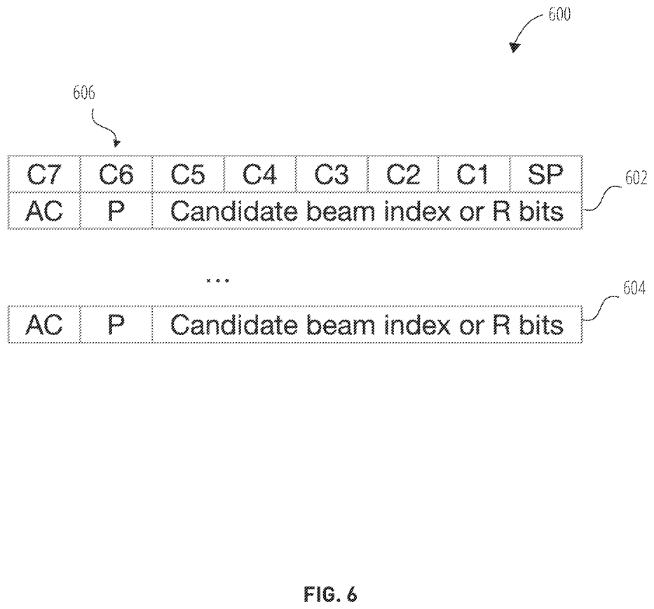

A first option is that a UE can report the panel entity index by MAC CE. For example, FIG. 6 shows a MAC CE-based BFRQ 600 for multiple candidate beams, including a first candidate beam 602 and a second candidate beam 604. Thus, in MAC CE-based BFRQ 600, each panel entity index is be reported per candidate beam. In another example, the panel entity index may be reported separately, per candidate beam.

The MAC CE format shown in FIG. 6 includes a placeholder 606 bit “P,” which indicates the panel entity index, e.g., first or second panel. Note that for a UE with more than two panels, more bits could be reserved for “P.” Other fields shown in FIG. 6 may be the same as in current specification under section 6.1.3.23 of 3GPP 38.321.

A second option is a default UE panel is assumed, which may be predefined. For example, a first UE panel or a UE panel having the smallest number of antenna ports, or a default panel reported by UE capability signaling.

In terms of UE behavior after it receives BFR response from a gNB, after X symbols (e.g. X=28), the UE behavior for the uplink channel transmission in the same CC can be defined as follows for PUSCH and PUCCH.

For PUSCH, the SRS resource set for codebook/non-codebook corresponding to the reported/assumed UE panel in BFRQ can be used for SRS resource indicator (SRI) indication. The PUSCH beam should be based on the reported beam. The pathloss for power control should be based on the SSB/CSI-RS indicated by the reported beam. Other power control parameters (e.g. P0, alpha, or closed-loop index) should be based on default power control parameter set corresponding to the reported/assumed panel. Alternatively, PUSCH can be scheduled by DCI format 0_0 until the UE receives a beam indication signaling.

For PUCCH, the beam should be based on the reported beam (the reported beam is the candidate beam reported in BFRQ). The pathloss for power control should be based on the SSB/CSI-RS indicated by the reported beam. Other power control parameters (e.g., P0, alpha, or closed-loop index) should be based on default power control parameter set corresponding to the reported/assumed panel.

For SRS, the SRS resource set corresponding to the selected/assumed UE panel can be triggered for transmission. In one example, the SRS resource set corresponding to the selected/assumed UE panel can be the one that share the same beam indication as the PUSCH.

In another example, for SRS for codebook, the SRS resource set corresponding to the selected/assumed UE panel can be the one with the number of SRS ports smaller than or equal to the maximum number of ports for the selected/assumed UE panel.

In yet another example, for SRS for antenna switching, the SRS resource set corresponding to the selected/assumed UE panel can be the one with same number of SRS ports as the maximum number of ports for the selected/assumed UE panel.

In still another example, for SRS for non-codebook, the SRS resource set corresponding to the selected/assumed UE panel can be the one with the number of SRS ports smaller than or equal to the maximum number of ports for the selected/assumed UE panel.

In one other example, for SRS for beam management, the SRS resource set corresponding to the selected/assumed UE panel can be the one with the number of SRS resources smaller than or equal to the maximum number of beams for the selected/assumed UE panel.

The beam for corresponding SRS resource set should be based on the reported beam. The pathloss for power control should be based on the SSB/CSI-RS indicated by the reported beam. Other power control parameters (e.g. P0, alpha, or closed-loop index) should be based on default power control parameter set corresponding to the reported/assumed panel.

Alternatively, none of the SRS for codebook/non-codebook/antenna switching should be triggered for transmission UE receives a beam indication signaling.

For channels in another CC within the same band or band group/combination, the following options are provided after UE receives the BFR response. And a UE can report its capability of which band combinations the options below should be applied to.

A first option is that the beam is reset based on the reported beam. The pathloss for power control should be based on the SSB/CSI-RS indicated by the reported beam. Other power control parameters (e.g. P0, alpha, or closed-loop index) should be based on default power control parameter set corresponding to the reported/assumed panel. This option may be applied for a subset of or all uplink channels/signals. For the applicable channels, reuse the UE behavior described previously (i.e., for PUSCH, PUCCH, and SRS) may be deployed.

A second option is that a UE should transmit the signals based on a default mode, i.e., the operation before RRC connection. The PUSCH can be scheduled by fallback mode DCI such as DCI format 0_0. The PUCCH is based on a default beam with default power control parameters. The UE can skip the SRS transmission.

A third option is that a UE maintains previous beam and configurations for uplink transmission in the “another CC.” When the uplink signals in the failed CC (reported in BFRQ) and the “another CC” are overlapped in time domain, a priority rule is introduced to drop signals. In one example, the priority rule is described below. Alternatively, a scheduling restriction can be introduced to avoid this collision.

The following is an example for priority rule (from high priority to low priority): (1) PRACH transmission on the PCell; (2) PUCCH or PUSCH transmissions with higher priority index; (3) for PUCCH or PUSCH transmissions with same priority index: (i) PUCCH transmission with HARQ-ACK information, and/or scheduling request (SR), and/or link recovery request (LRR), or PUSCH transmission with HARQ-ACK information, (ii) PUCCH transmission with CSI or PUSCH transmission with CSI. (iii) PUSCH transmission without HARQ-ACK information or CSI and, for Type-2 random access procedure, PUSCH transmission on the PCell; (4) SRS transmission, with aperiodic SRS having higher priority than semi-persistent and/or periodic SRS, or PRACH transmission on a serving cell other than the PCell.

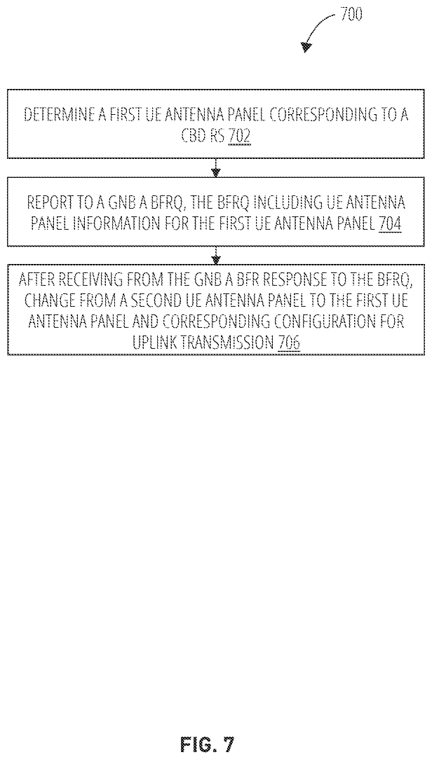

FIG. 7 shows a process 700, performed by a UE, of BFR with uplink antenna panel selection. In block 702, the UE determines a first UE antenna panel corresponding to a CBD RS. For this new candidate beam, the UE will report the panel information. In block 704, the UE reports to a gNB a BFRQ, the BFRQ including UE antenna panel information for the first UE antenna panel. In block 706, after receiving from the gNB a BFR response to the BFRQ, the UE changes from a second IE antenna panel to the first UE antenna panel and corresponding configuration for uplink transmission. Thus, the new beam would be automatically applied for uplink transmission after BFR is finished. When this candidate beam is selected, UE would use the panel. One example is that this panel is the one among the panels with highest performance, e.g., highest reference signal received power.

Process 700 may also include the BFRQ being a CFRA based BFRQ. Process 700 may also include the CFRA based BFRQ being provided in a CF-PRACH resource configured by the gNB to correspond to the first UE antenna panel.

Process 700 may also include the BFRQ being a MAC CE based BFRQ including a panel entity index. Process 700 may also include reporting the panel entity index per candidate beam. Process 700 may also include reporting the panel entity index for multiple candidate beams.

Process 700 may also include changing to the first UE antenna panel and corresponding configuration for uplink transmission of signals within a CC. Process 700 may also include changing to the first UE antenna panel and corresponding configuration for uplink transmission of signals in multiple CCs within a band or band group. Process 700 may also include, for a channel in another CC that is within a same band or band group as that of the uplink transmission, resetting a beam of the CC based on a candidate beam of the BFRQ. Process 700 may also include, for a channel in another CC that is within a same band or band group as that of the uplink transmission, maintaining previous beam and uplink configurations for an uplink transmission in the other CC.

Process 700 may also include configuring a PUSCH by employing an SRS resource set corresponding to the first UE antenna panel for SRI indication. Process 700 may also include transmitting a PUSCH according to a schedule in DCI format 0_0 until the UE receives beam indication signaling. Process 700 may also include skipping transmission of an SRS until the UE receives beam indication signaling.

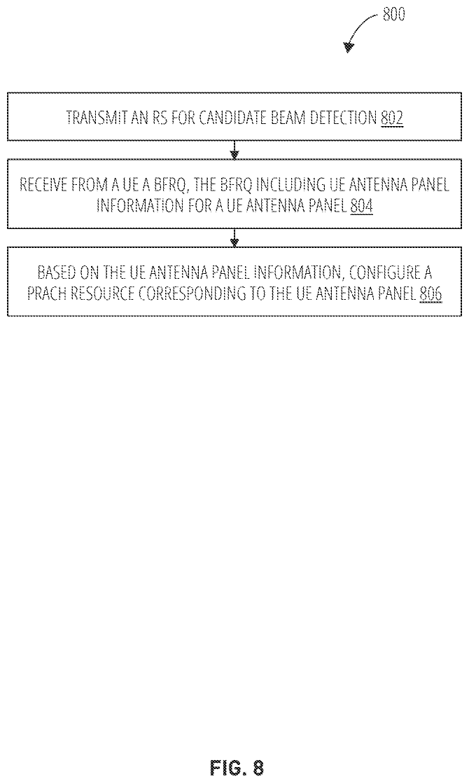

FIG. 8 shows a process 800, performed by a gNB, of BFR with uplink antenna panel selection. In block 802, process 800 transmits a RS for candidate beam detection. In block 804, process 800 receives from a UE a BFRQ, the BFRQ including UE antenna panel information for a UE antenna panel. In block 806, based on the UE antenna panel information, process 800 b configures a PRACH resource corresponding to the UE antenna panel.

Process 800 may also include the UE antenna panel information specified in a MAC CE format. Process 800 may also include the UE antenna panel information specified in a PRACH-ResourceDedicatedBFR information element. Process 800 may also include receiving from the UE an uplink transmission using the UE antenna panel and a reported beam.

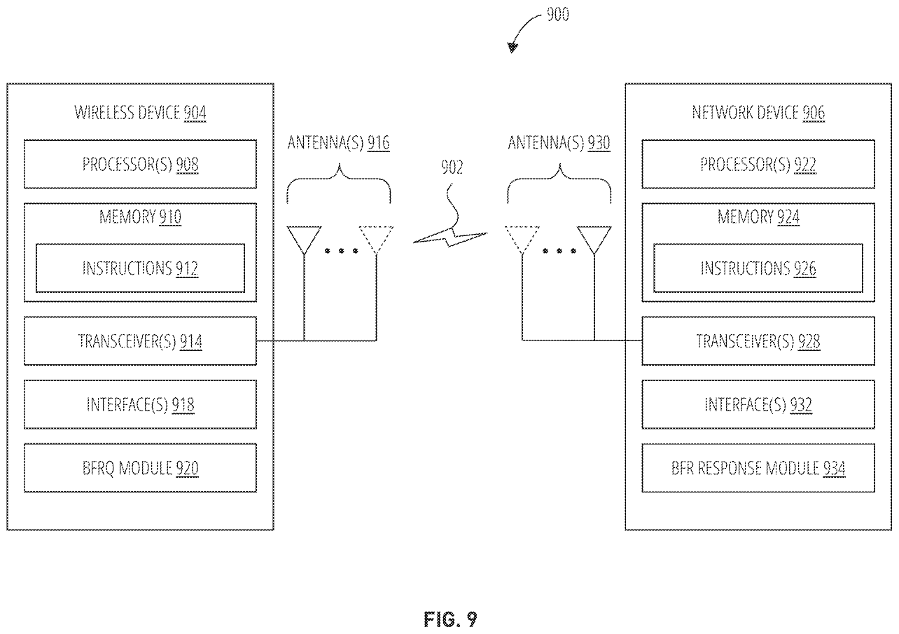

FIG. 9 illustrates a system 900 for performing signaling 902 between a wireless device 904 and a network device 906, according to embodiments disclosed herein. System 900 may be a portion of a wireless communications system as herein described. Wireless device 904 may be, for example, a UE of a wireless communication system. Network device 906 may be, for example, a base station (e.g., an eNB or a gNB) of a wireless communication system. Wireless device 904 may include one or more processor(s) 908. Processor(s) 908 may execute instructions such that various operations of wireless device 904 are performed, as described herein. Processor(s) 908 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

Wireless device 904 may include a memory 910. Memory 910 may be a non-transitory computer-readable storage medium that stores instructions 912 (which may include, for example, the instructions being executed by processor(s) 908). Instructions 912 may also be referred to as program code or a computer program. Memory 910 may also store data used by, and results computed by, processor(s) 908.

Wireless device 904 may include one or more transceiver(s) 914 that may include radio frequency (RF) transmitter and/or receiver circuitry that use antenna(s) 916 of wireless device 904 to facilitate signaling (e.g., signaling 902) to and/or from wireless device 904 with other devices (e.g., network device 906) according to corresponding RATs.

Wireless device 904 may include one or more antenna(s) 916 (e.g., one, two, four, or more). For embodiments with multiple antenna(s) 916, wireless device 904 may leverage the spatial diversity of such multiple antenna(s) 916 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by wireless device 904 may be accomplished according to precoding (or digital beamforming) that is applied at wireless device 904 that multiplexes the data streams across antenna(s) 916 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, wireless device 904 may implement analog beamforming techniques, whereby phases of the signals sent by antenna(s) 916 are relatively adjusted such that the (joint) transmission of antenna(s) 916 can be directed (this is sometimes referred to as beam steering).

Wireless device 904 may include one or more interface(s) 918. Interface(s) 918 may be used to provide input to or output from wireless device 904. For example, a wireless device 904 that is a UE may include interface(s) 918 such as microphones, speakers, a touchscreen, buttons, and the like in order to allow for input and/or output to the UE by a user of the UE. Other interfaces of such a UE may be made up of made up of transmitters, receivers, and other circuitry (e.g., other than transceiver(s) 914/antenna(s) 916 already described) that allow for communication between the UE and other devices and may operate according to known protocols (e.g., Wi-Fi®, Bluetooth®, and the like).

Wireless device 904 may include a BFRQ module 920. BFRQ module 920 may be implemented via hardware, software, or combinations thereof. For example, BFRQ module 920 may be implemented as a processor, circuit, and/or instructions 912 stored in memory 910 and executed by processor(s) 908. In some examples, BFRQ module 920 may be integrated within processor(s) 908 and/or transceiver(s) 914. For example, BFRQ module 920 may be implemented by a combination of software components (e.g., executed by a DSP or a general processor) and hardware components (e.g., logic gates and circuitry) within processor(s) 908 or transceiver(s) 914.

BFRQ module 920 may be used for various aspects of the present disclosure, for example, aspects of FIG. 4 or FIG. 7. For example, BFRQ module 920 is configured to facilitate process 700.

Network device 906 may include one or more processor(s) 922. Processor(s) 922 may execute instructions such that various operations of network device 906 are performed, as described herein. Processor(s) 908 may include one or more baseband processors implemented using, for example, a CPU, a DSP, an ASIC, a controller, an FPGA device, another hardware device, a firmware device, or any combination thereof configured to perform the operations described herein.

Network device 906 may include a memory 924. Memory 924 may be a non-transitory computer-readable storage medium that stores instructions 926 (which may include, for example, the instructions being executed by processor(s) 922). Instructions 926 may also be referred to as program code or a computer program. Memory 924 may also store data used by, and results computed by, processor(s) 922.

Network device 906 may include one or more transceiver(s) 928 that may include RF transmitter and/or receiver circuitry that use antenna(s) 930 of network device 906 to facilitate signaling (e.g., signaling 902) to and/or from network device 906 with other devices (e.g., wireless device 904) according to corresponding RATs.

Network device 906 may include one or more antenna(s) 930 (e.g., one, two, four, or more). In embodiments having multiple antenna(s) 930, network device 906 may perform MIMO, digital beamforming, analog beamforming, beam steering, etc., as has been described.

Network device 906 may include one or more interface(s) 932. Interface(s) 932 may be used to provide input to or output from network device 906. For example, a network device 906 that is a base station may include interface(s) 932 made up of transmitters, receivers, and other circuitry (e.g., other than transceiver(s) 928/antenna(s) 930 already described) that enables the base station to communicate with other equipment in a core network, and/or that enables the base station to communicate with external networks, computers, databases, and the like for purposes of operations, administration, and maintenance of the base station or other equipment operably connected thereto.

Network device 906 may include a BFR response module 934. BFR response module 934 may be implemented via hardware, software, or combinations thereof. For example, BFR response module 934 may be implemented as a processor, circuit, and/or instructions 926 stored in memory 924 and executed by processor(s) 922. In some examples, BFR response module 934 may be integrated within processor(s) 922 and/or transceiver(s) 928. For example, BFR response module 934 may be implemented by a combination of software components (e.g., executed by a DSP or a general processor) and hardware components (e.g., logic gates and circuitry) within processor(s) 922 or transceiver(s) 928.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method, performed by a user equipment (UE), of beam failure recovery (BFR) with uplink antenna panel selection, the method comprising:
determining a first UE antenna panel corresponding to a candidate beam detection (CBD) reference signal (RS);
reporting to a gNB a beam failure recovery request (BFRQ), the BFRQ including UE antenna panel information for the first UE antenna panel; and
after receiving from the gNB a BFR response to the BFRQ, changing from a second UE antenna panel to the first UE antenna panel and corresponding configuration for uplink transmission.

2. The method of claim 1, further comprising changing to the first UE antenna panel and the corresponding configuration for uplink transmission of signals within a component carrier.

3. The method of claim 1, further comprising changing to the first UE antenna panel and the corresponding configuration for uplink transmission of signals in multiple component carriers within a band or band group.

4. The method of claim 1, in which the BFRQ is a contention-free random access (CFRA) based BFRQ.

5. The method of claim 4, in which the CFRA based BFRQ is provided in a contention-free physical random access channel (PRACH) resource configured by the gNB to correspond to the first UE antenna panel.

6. The method of claim 1, in which the BFRQ is a media access control (MAC) control element (CE) based BFRQ, the method further comprising reporting a panel entity index by MAC CE.

7. The method of claim 6, further comprising reporting the panel entity index per candidate beam.

8. The method of claim 6, further comprising reporting the panel entity index for multiple candidate beams.

9. The method of claim 1, further comprising configuring a physical uplink shared channel (PUSCH) by employing a sounding reference signal (SRS) resource set corresponding to the first UE antenna panel for SRS resource indicator (SRI) indication.

10. (canceled)

11. The method of claim 1, further comprising transmitting a physical uplink shared channel (PUSCH) according to a schedule in downlink control information (DCI) format 0_0 until the UE receives beam indication signaling.

12. The method of claim 1, further comprising skipping transmission of a sounding reference signal (SRS) until the UE receives beam indication signaling.

13. (canceled)

14. A non-transitory computer-readable storage medium of a user equipment (UE) configured for beam failure recovery (BFR) with uplink antenna panel selection, the computer-readable storage medium including instructions that when executed by a processor of the UE, cause the UE to:
determine a first UE antenna panel corresponding to a candidate beam detection (CBD) reference signal (RS);
report to a gNB a beam failure recovery request (BFRQ), the BFRQ including UE antenna panel information for the first UE antenna panel; and
after receiving from the gNB a BFR response to the BFRQ, change from a second UE antenna panel to the first UE antenna panel and corresponding configuration for uplink transmission.

15. The computer-readable storage medium of claim 14, in which the instructions further cause the UE to change to the first UE antenna panel and the corresponding configuration for uplink transmission of signals within a component carrier.

16. The computer-readable storage medium of claim 14, in which the instructions further cause the UE to change to the first UE antenna panel and the corresponding configuration for uplink transmission of signals in multiple component carriers within a band or band group.

17. The computer-readable storage medium of claim 14, in which the BFRQ is a contention-free random access (CFRA) based BFRQ.

18. The computer-readable storage medium of claim 17, in which the CFRA based BFRQ is provided in a contention-free physical random access channel (PRACH) resource configured by the gNB to correspond to the first UE antenna panel.

19-26. (canceled)

27. A method, performed by a gNB, of beam failure recovery (BFR) with uplink antenna panel selection, the method comprising:
transmitting a reference signal (RS) for candidate beam detection;
receiving from a UE a beam failure recovery request (BFRQ), the BFRQ including UE antenna panel information for a UE antenna panel; and
based on the UE antenna panel information, configuring a physical random access channel (PRACH) resource corresponding to the UE antenna panel.

28. The method of claim 27, in which the UE antenna panel information is specified in a media access control (MAC) control element (CE) format.

29. The method of claim 27, in which the UE antenna panel information is specified in a PRACH-ResourceDedicatedBFR information element.

30. The method of claim 27, further comprising receiving from the UE an uplink transmission using the UE antenna panel and a reported beam.

31-34. (canceled)
